(19) United States
(12) Patent Application Publication
(10) Pub. No.: US 2005/0114572 A1
(43) Pub. Date: May 26, 2005

(54) Home network service platform apparatus employing IEEE 1394

(76) Inventors: Hee-Won Cheung, Suwon-si (KR); Do-In Choi, Yongin-si (KR); Yun-Je Oh, Yongin-si (KR); Lae-Kyoung Kim, Suwon-si (KR)

Correspondence Address: CHA & REITER, LLC, 210 ROUTE 4 EAST STE 103, PARAMUS, NJ, 07652, US

(21) Appl. No.: 10/862,252

(22) Filed: Jun. 7, 2004

(30) Foreign Application Priority Data
Nov. 10, 2003 (KR) 2003-79209

(51) Int. Cl. G06F 13/38

(52) U.S. Cl. 710/62

(57) ABSTRACT

A network service platform apparatus employing an IEEE 1394 protocol is disclosed. The network service platform apparatus includes a first optical transceiver connected to an external service gateway to receive downstream data from the external service gateway and transfer upstream data to the external service gateway, a first IEEE 1394 physical unit connected to the first optical transceiver to perform a physical layer operation of an IEEE 1394 protocol with respect to the downstream data, and to transfer the upstream data to the first optical transceiver, and an IEEE 1394 link unit connected to the first IEEE 1394 physical unit to deliver isochronous data of the downstream data by performing a link layer operation of the IEEE 1394 protocol, and to send asynchronous data to be delivered to the service gate to the first IEEE 1394 physical unit as upstream data by performing the link layer operation of the IEEE 1394 protocol with respect to the asynchronous data. In addition, the home network service platform apparatus includes an Application Protocol Interface connected to the IEEE 1394 link unit to output IEEE 1394 isochronous data, an IEEE 1394 bridge unit having a first bus connected to the first IEEE 1394 physical unit and a second bus connected to the first IEEE 1394 physical unit in order to transmit/receive data between the first bus and the second bus, and a second IEEE 1394 physical unit which is connected to the IEEE 1394 bridge unit through the second bus and connected to an IEEE 1394 unit using a bus independent of the IEEE 1394 apparatus.

### CLAIM OF PRIORITY

This application claims priority pursuant to 35 USC §119 to that patent application entitled “Home network service platform apparatus employing IEEE 1394” filed in the Korean Intellectual Property Office on Nov. 10, 2003 and assigned Ser. No. 2003-79209, the contents of which are hereby incorporated by reference.

### BACKGROUND OF THE INVENTION

1. Field of the Invention

The present invention relates to IEEE 1394 protocol base network systems and, more particularly, network systems that may be used in a home or office.

2. Description of the Related Art

Transmission methods that have been proposed as home network solutions, employ communication protocols such as Ethernet, PLC (power line communication), Home Phoneline Networking Alliance, IEEE (Institute of Electrical and Electronics Engineers) 1394, WLL (Wireless Local Loop), etc. These proposed transmission methods have their intrinsic strengths and weaknesses with regard to speed, capacity and reliability.

A sufficient bandwidth and a QoS (Quality of Service) guarantee are major criteria with regard to multimedia transmission considered in a network that may be used in a home or office. The IEEE 1394 protocol standard is well-known as the one method that can provide necessary bandwidth and the QoS guarantee from among the transmission methods noted above. Also, the IEEE 1394 is expected to be a standard for future home network solution.

An IEEE 1394 protocol method is a serial bus interface standard that has been commonly proposed by Apple Co. and Texas Instrument Co. and has been developed under the code name “FIREWIRE”. The IEEE 1394 protocol standard, which has been researched since 1986, was publicly issued and standardized by the Institute of Electrical and Electronics Engineers (IEEE) in December, 1995.

When processing isochronous data (e.g., streaming AudioVideo data), which is frequently used for transmitting multimedia information, and a synchronous data (control and packet data), which is used for communication and control information, the IEEE 1394 standard is capable of connecting 63 nodes (maximum) in a serial bus interface and provides priority to the isochronous data. Thus, IEEE 1394 standard can guarantee a high level Quality of Service for multimedia data. In addition, a second standard, referred to as IEEE 1394a, suggests even higher bit rates, e.g., S100, S200, and S400, and a recently-issued IEEE 1394b protocol is suitable for optical media such as POF (Plastic Optical Fiber), GOF (Glass Optical Fiber), MMF (Multimode Fiber), etc., so that even higher bit rates, e.g., 3.2 Gbps (giga bits/sec), may be achieved. The IEEE 1394 protocol standard is, thus, expected to provide an efficient solution for the home network and remote data communication.

FIG. 1 illustrates a conventional network employing the IEEE 1394 protocol. As shown in FIG. 1, the IEEE 1394 protocol network configuration is based on a tree topology having a daisy chain mode among the connected devices. The conventional network structure employing the IEEE 1394 protocol includes an SG (service gateway) 100 for providing a connection route to high-ranked networks (branches) and nodes 101-1 to 101-10 providing connection to lower-ranked nodes or networks (sub-branches).

A network according to the IEEE 1394 protocol having the above structure is designed to carry out various functions such as an “auto-configuration function”, “plug & play”, “hot plug in”, etc., real-time isochronous transmission, and asynchronous transmission. For this reason, the network of the IEEE 1394 protocol can be very useful in a home network as it provides distribution of different kinds of data and convenience for the user.

The IEEE 1394 has an intrinsic advantage in its use as a network communication protocol. However, networks based on a tree topology having a daisy chain among devices posses a significant problem when devices are connected or disconnected from the network

FIG. 2 illustrates an example of a bus reset derived from a separation or disconnection of a device in a conventional daisy chain structure employing the IEEE 1394 protocol. As shown in FIG. 2, in the event of a disconnection of an appliance acting as a node connected to a system bus or power-off of an appliance all nodes connected to the bus must be reset and re-configured as the configuration has changed. Therefore, when an appliance, such as a digital camcorder, that does not employ an IEEE 1394 protocol is disconnected from a network employing the IEEE 1394 protocol the entire network may become unstable and require a reset of the entire network A similar unstable condition occurs when a device, even a non-IEEE 1394 based device, is connected to the network.

Thus, in a daisy chain structure network topology shown including in FIG. 1, when the second apparatus 22 (see FIG. 2) is separated from a predetermined position (shown as an arrow), the remain nodes, i.e., first apparatus 21 and the third apparatus 24, connected to all buses must be reset and re-configured. Furthermore, since data communication with the third apparatus 24 is abruptly stopped, data loss can occur.

The conventional daisy chain structure employing the IEEE 1394 protocol has an additional problem in that an appliance playing the role of a middle branch node has to be remain in a “powered-on” state in order to operate or communicate with a node or appliance connected at a lower branch node.

As all system buses are reset whenever devices of an IEEE 1394 protocol network are powered on or off, the conventional daisy chain structure employing the IEEE 1394 protocol has still another problem in that a high level QoS is not guaranteed during transmission of multimedia data. Therefore, it is important that the problems described above be resolved in order to construct an IEEE-1394 based network that may be suitable for home or office networks.

### SUMMARY OF THE INVENTION

A first object of the present invention is to provide an apparatus as a network node employing an IEEE 1394 protocol wherein it is not required to reset all system buses when nodes, devices or appliances are connected or disconnected from the network.

A second object of the present invention is to provide an apparatus as a network node employing an IEEE 1394b protocol that can be utilized over a wide space by extending a maximum distance between conventional appliances to 50 m.

A third object of the present invention is to provide an apparatus as a network node employing an IEEE 1394 protocol that includes a built-in node platform apparatus that can be integrally formed with an existing power-line concentric plug so as to allow users to easy access to the network.

In order to accomplish these objects, according to an aspect of the present invention, there is provided a network service platform apparatus employing an IEEE 1394 protocol comprising a first optical transceiver connected to an external service gateway to receive downstream data from the external service gateway and transfer upstream data to the external service gateway, a first IEEE 1394 protocol physical unit connected to the first optical transceiver to perform a physical layer operation of an IEEE 1394 protocol with respect to the downstream data, and to transfer the upstream data to the first optical transceiver, an IEEE 1394 link unit connected to the first IEEE 1394 physical unit to deliver isochronous downstream data by performing a link layer operation of the IEEE 1394 protocol, and to send asynchronous data to be delivered to the service gate to the first IEEE 1394 physical unit as upstream data by performing the link layer operation of the IEEE 1394 protocol with respect to the asynchronous data, an API (Application Protocol Interface) connected to the IEEE 1394 link unit to output IEEE 1394 isochronous data by transforming IEEE 1394 isochronous data, which are delivered through the link layer operations of the IEEE 1394 protocol performed by the IEEE 1394 link unit, such that the IEEE 1394 isochronous data have predetermined multimedia data formats, an IEEE 1394 bridge unit having a first side connected to the first IEEE 1394 physical unit so as to use a first bus and a second side, which uses a second bus different from the first bus unit in order to transmit/receive data between the first bus and the second bus, a second IEEE 1394 protocol physical unit which is connected to the IEEE 1394 bridge unit through the second bus and connected to an IEEE 1394 unit using a bus independent from the IEEE 1394 service platform apparatus, and a control part which is connected to the IEEE 1394 link unit and the IEEE 1394 bridge unit and controls processing for the IEEE 1394 protocol and isochronous data.

### BRIEF DESCRIPTION OF THE DRAWINGS

The above and other objects, features and advantages of the present invention will be more apparent from the following detailed description taken in conjunction with the accompanying drawings, in which:

FIG. 1 is a view showing a conventional network structure employing IEEE 1394 protocol;

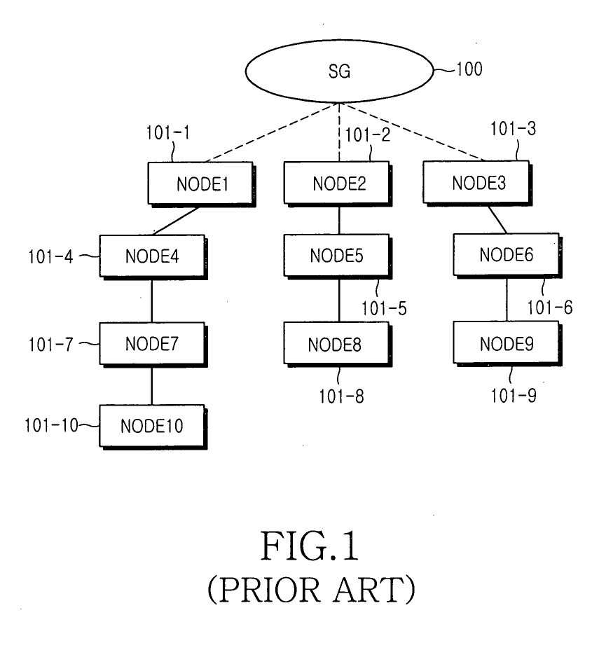

FIG. 2 is a view showing an example of a bus reset derived from a disconnection of an appliance caused by a conventional daisy chain structure employing IEEE 1394 protocol;

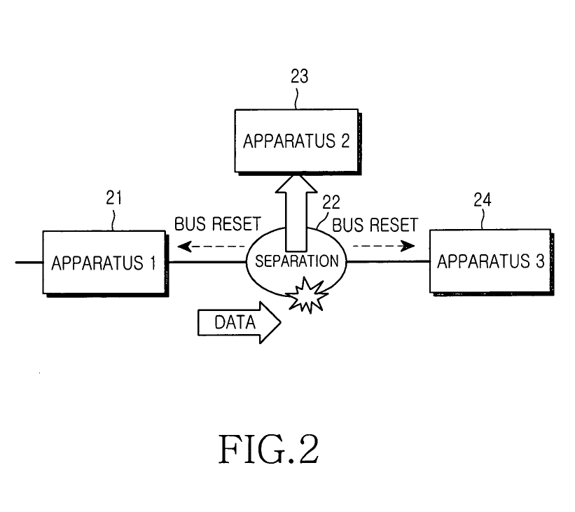

FIG. 3 is a view showing a structure of an IEEE 1394 protocol based network according to one embodiment of the present invention; and

FIG. 4 is a view showing an internal structure of an IEEE 1394based network service platform apparatus (SP) used in the an IEEE 1394 protocol based network shown in FIG. 3.

### DETAILED DESCRIPTION OF THE INVENTION

Hereinafter, preferred embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

Terminology used for the present invention will be first defined before describing the exemplary embodiment of the present invention. Hereinafter, an “internal network” and an “external network” are used in describing the present invention. The “internal network” refers to a network formed between an SP, which is a network node apparatus according to the present invention, and devices, apparatus, or appliances connected to the SP. The “external network” refers to a network formed between the SP, which is a network node apparatus according to the present invention, and an SG (service gateway) connected to the SP. Also, the “external network” refers to a network formed between the SP and another IEEE 1394 node connected to the SP.

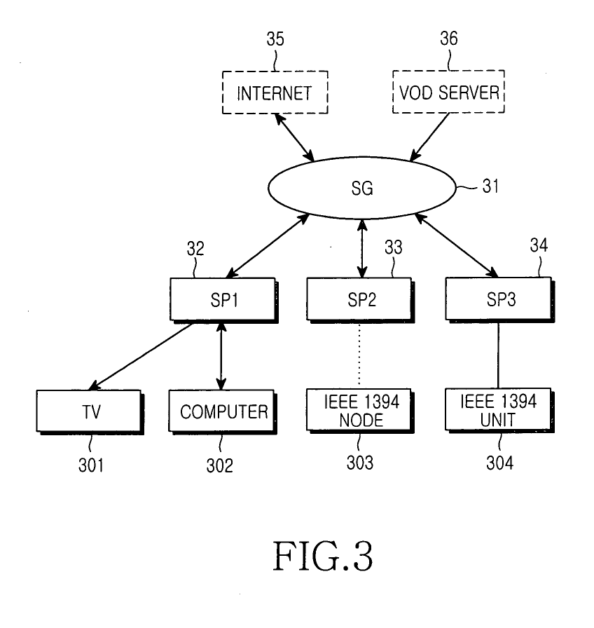

FIG. 3 is a view showing a structure of an IEEE 1394 protocol based network according to one embodiment of the present invention. As shown in FIG. 3, the IEEE 1394-based network includes an SG (service gateway) 31 and a plurality of SPs 32-34. SG 31 is connected, in this illustrated example, to external network 35 (e.g., Internet) and external VOD (video on demand) service 36 and transfers data that is delivered from either the external Internet 35 or the external VOD 36, or both, to internal devices of the IEEE 1394-based network. SPs 32-34 are connected to SG 31 through an IEEE 1394 communication protocol and receive data from SG 31 to be delivered to user's appliances, other internal devices or to other networks, as required.

SG 31 is connected to each of the SPs 32-34 in a one-to-one method without forming a tree structure topology. Each of the SPs 32-34 is maintained in a power-on state or condition. As shown in FIG. 3, SPs 32-34 can be connected to devices, apparatus or appliances, such as television (TV) 301, computer 302, another IEEE 1394 protocol based device 304, or another IEEE 1394 protocol based node 303.

Operations of the SPs 32-34 will now be described in detail. SPs 32-34 communicate with SG 31 in the IEEE 1394 mode. However, when each of the SPs 32-34 communicates with an appliance such as a TV 301 that does not communicate via the IEEE 1394 protocol, SPs 32-34 according to one embodiment of the present invention transforms the received IEEE 1394-based data through a method adaptable for the corresponding appliance. In this case, a bus reset does not occur when an appliances, such as TV 301 that does not employ the IEEE 1394-based protocol is connected to or disconnected from the system.

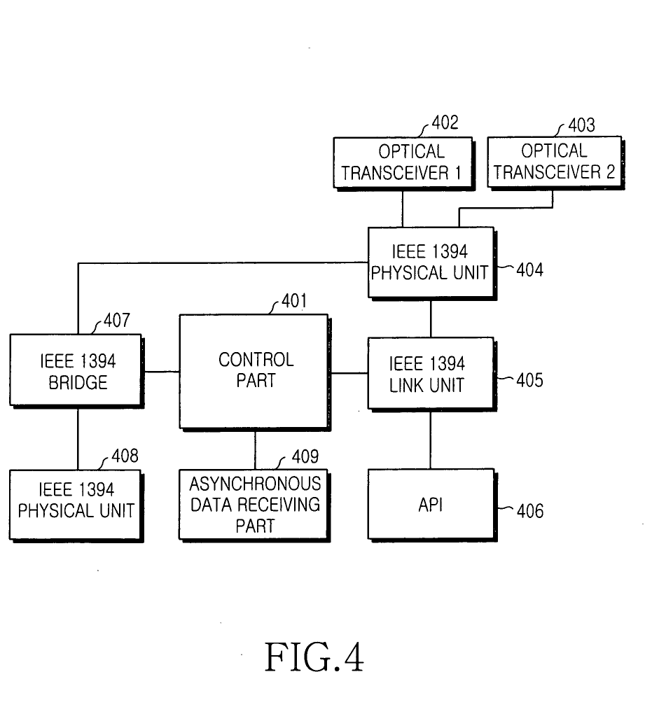

SPs 32-34 can also be connected to an IEEE 1394-based unit 304 through the IEEE 1394 method and a bus reset will not occur even though the IEEE 1394-based unit 304 is connected to or disconnected from the SPs 32-34. as will be more fully explained with regard to FIG. 4.

FIG. 4 illustrates a block diagram of an IEEE 1394-based network service platform apparatus (SP) in accordance with the principles of the invention that can be used in the IEEE 1394 network shown in FIG. 3. As shown in FIG. 4, the SP includes a first optical transceiver 402, a second optical transceiver 403, a first IEEE 1394 physical unit 404, an IEEE 1394 link unit 405, a second IEEE 1394 physical unit 408, an IEEE bridge unit 407, an API (application protocol interface) 406, an asynchronous data receiving part 409, and a control part 401. The first optical transceiver 402 is used for communication with SG 31. The second optical transceiver 403 is used for communication with another IEEE 1394 node (not shown). The first IEEE 1394 physical unit 404 operates as on an IEEE 1394 physical layer to receive/transmit IEEE 1394 data through an external network. Although the present invention is described with regard to first optical transceiver 402 in communication with SG 31 and the second optical transceiver 403 in communication with a, not shown, second network, it would be well within the skill of those in the art to alter the connections without deviating from the scope of the invention.

The IEEE 1394 link unit 405 is used for operation on the data link layer of the IEEE 1394 data. The second IEEE 1394 physical unit 408 is used for a connection to another IEEE 1394 based unit (not shown). The IEEE 1394 bridge unit 407 allows the first IEEE 1394 physical unit 404 and the second IEEE 1394 physical unit 408 to use different buses and transforms data delivered through the different buses so as to transfer the transformed data to the first IEEE 1394 physical unit 404 and the second IEEE 1394 physical unit 408. The API (application protocol interface) 406 is connected to the IEEE 1394 link unit 405 and transfers isochronous data multimedia data to a corresponding application appliance or device by transforming the multimedia data into signals suitable for the corresponding application appliance or device. The asynchronous data receiving part 409 receives asynchronous data transferred from a user's remote controller, or the like, and transfers the asynchronous data to a high-ranked network (i.e., SG). The control part 401 is connected to the IEEE 1394 link unit 405, the IEEE 1394 bridge unit 407, and the asynchronous data receiving part 409, and controls the operations of the SP including asynchronous data processing and data processing according to an IEEE 1394 protocol.

Operations of the SP according to the present invention are now described in detail with reference to the network structure shown in FIG. 3 and components shown in FIG. 4.

First, the first optical transceiver 402 receives data from external networks though SG 31 and opto-electrically converts the data to a format suitable for transfer to internal units. The first optical transceiver 402 also electro-optically converts upstream signals delivered from the internal units to transfer the upstream signal to the external networks through SG 31. Definitions regarding optical transmission is not suggested in an IEEE 1394a protocol but is suggested in an IEEE 1394b protocol, hence it need not be explained in detail herein. In particular, according to the present invention, POF (plastic optical fiber) is preferably used for transmission of the transformed optical signals.

Second optical transceiver 403 is used for forming a topology of a daisy chain structure identical to a conventional of a daisy chain topology, for converting data delivered from another SP or from the external network into an optical signal for delivery to a node below the instant SP and for receiving data from an SP of a node below the instant SP.

First IEEE 1394 physical unit 404 operates on a physical layer in order to receive/transmit IEEE 1394 data, which are opto-electrically converted and delivered by the first optical transceiver or the second optical transceiver.

Processing of data from the external network to the internal network, referred to as downstream data, will now be described. The first IEEE 1394 physical unit 404 receives data from the first optical transceiver 402 and checks whether the data is multimedia data. If the data is deemed multimedia data, the first IEEE 1394 physical unit 404 sends the data to the IEEE 1394 link unit 405 in such a manner that the data is received by an AV unit through the API 406. In addition, first IEEE 1394 physical unit 404 receives data from the first optical transceiver 402 and checks whether the data is data to be used for the IEEE 1394 unit 304 (referred to in FIG. 3). If the data is to be sent to the IEEE 1394 unit 304, the first IEEE 1394 physical unit 404 sends the data to the IEEE 1394 bridge unit 407 in such a manner that the data are delivered to the second IEEE 1394 physical unit 408 through a bus different than that bus used by the first IEEE 1394 physical unit 404. Also, if the first IEEE 1394 physical unit 404 receives data to be delivered to a low-ranked IEEE 1394 node from the first optical transceiver 402, the first IEEE 1394 physical unit 404 delivers the data to the second optical transceiver 403 in such a manner that the data are sent to the low-ranked IEEE 1394 node.

Processing of data from the internal network to the external network, referred to as upstream data, will now be described. In this case, first IEEE 1394 physical unit 404 transfers upstream signals, which are delivered through the IEEE bridge unit 407 from the IEEE 1394 unit 304 of the internal network, to the external network through the first optical transceiver 402. Also, the first IEEE 1394 physical unit 404 receives asynchronous data, which have been received by the asynchronous data receiving part 409, through the control part 401 and the IEEE 1394 link unit 405. Thereafter, the first IEEE 1394 physical unit 404 transfers the asynchronous data to the external network through the first optical transceiver 402.

In addition, the IEEE 1394 link unit 405 operates as on a data link layer of the IEEE 1394 data. The IEEE 1394 link unit 405 delivers the IEEE 1394 data, which are sent from the first IEEE 1394 physical unit 404, to the API 406 under control of the control part 401. The IEEE 1394 link unit 405 receives asynchronous data, which have been received by the asynchronous data receiving part 409, through the control part 401 and delivers the asynchronous data to the first IEEE 1394 physical unit 404.

API 406 also converts multimedia data, which is delivered through the IEEE 1394 link unit 405, into data having a format suitable for a corresponding AV device so as to transfer the converted data to the AV device. For example, API 406 may convert IEEE 1394 data into RGB (red-green-blue) data or component data (image color difference data), DVI data prior as to transferring the converted data to the AV device connected thereto.

Second IEEE 1394 physical unit 408 and the IEEE 1394 bridge unit 407 are used for a connection to the IEEE 1394 unit 304 to the lower-branched node or network. The second IEEE 1394 physical unit 408 is connected to the IEEE 1394 unit 304 of the internal network and transmits/receives data in IEEE 1394a mode.

The IEEE 1394 bridge unit 407 assigns a second bus, referred to as bus B, different from a first bus, referred to as bus A, that is used by the upper-branched network, and the first IEEE 1394 physical unit 404 and the IEEE 1394 link unit 405 to the second IEEE 1394 physical unit 408 in order to establish an independent IEEE 1394 communication path with the upper network. IEEE 1394 bridge unit 407 provides an interconnecting communication path for the two buses A and B.

More specifically, the IEEE 1394 bridge unit 407 changes the bus A into the bus B so as to send IEEE 1394 data, which are delivered through the bus A from the first IEEE 1394 physical unit 404 to the second IEEE 1394 physical unit 408 under a control of the control part 401. The IEEE 1394 bridge unit 407 also changes the bus B into the bus A so as to send IEEE 1394 data, which are upwardly delivered through the bus B from the second IEEE 1394 physical unit 408, to the first IEEE 1394 physical unit 404. In other words, the IEEE 1394 bridge unit 407 reassigns bus numbers in such a manner that a bus reset and a configuration of the IEEE 1394 unit 304 connected to the SP do not exert an influence on units external to the instant SP.

Asynchronous data receiving part 409 receives asynchronous data from a user and delivers the asynchronous data to the control part 40. The asynchronous data may include channel selection information provided through, for example, a remote controller and/or upstream signals of a bidirectional TV.

Control part 401 processes an IEEE protocol stack and asynchronous data and is connected to the IEEE 1394 link unit 405, the IEEE 1394 bridge unit 407, and the asynchronous data receiving part 409. The operation of the control part 401 will now be described. The control part 401 controls the IEEE 1394 bridge unit 407 to independently connect the IEEE 1394 unit 304 (see FIG. 3) of the internal network to the SP so that a system bus reset does not occur. Also, the control part 401 receives asynchronous data from the asynchronous data receiving part 409 and delivers the asynchronous data to the IEEE 1394 link unit 405 in such a manner that the asynchronous data are upwardly delivered as IEEE 1394 data.

The operation of an SP used in an IEEE 1394 protocol based network having the structure shown in FIG. 4 will now be described in more detail.

First, procedures of delivering downstream data will now be described in more detail. IEEE 1394 data delivered from the SG 31 are sent to the first optical transceiver 401 of each SP through POF and opto-electrically converted or transformed. Transformed data is inputted to the first IEEE 1394 physical unit 403. The optical transceivers 402 and 403 included in the SP preferably employ VCSEL operating at 650 nm, as a light source, which provides a bit rate of 400 Mbps. Optical transceivers 402 to 403 are coupled with photodetectors (PDs) capable of receiving light corresponding to a transmitting part in order to receive data and operating driver integrated circuits, which are well-known in the art. In addition, when optical data is opto-electrically converted by the first optical transceiver 401, the optical data is outputted as NRZ (Non-Return Zero) data of 8 bits/10 bits.

The outputted NRZ data is delivered to the API 406 through the first IEEE 1394 physical unit 404 and the IEEE 1394 link unit 405 as parallel data of 8 bits. The API 406 transforms the parallel data in such a manner that the parallel data have data formats required by devices or appliances external to the SP to allow output of the transformed data and proper reception of same. The data formats of the external units may include a component-type data format for a connection to a digital TV, a HD (high definition) set-top box, an RGB (red, green, and blue) type (D-SUB) data format for a connection to a PC, or a DVI (digital video interface) type data format. Accordingly, AV units connected through the API 406 can communicate with the SP through a conventional AV data transmission method without providing the IEEE 1394 data communication method to the AV units. Asynchronous packet data can be delivered to the control part 401 through the first IEEE 1394 physical unit 404 and the IEEE 1394 link unit 405. The control part 401 sends the delivered asynchronous packet data to corresponding destination address.

In addition, different buses are provided through the IEEE 1394 bridge unit 407 defined in IEEE 1394.1 protocol standard to provide an independent environment in relation to IEEE 1394 appliances so that it is not required to reset all buses of in the network when appliances are connected to or disconnected from the network.

It is possible for the SP according to the present invention to form an IEEE 1394 network that does not have a topology of a daisy chain structure or a tree structure, but has an independent structure, through the above-described structure. Thus, even though appliances are powered on/off or connected or disconnected, it is unnecessary to perform bus reset for appliances connected to the API 406 because the appliances connected to the API 406 do not employ the IEEE 1394 method. Also, since the IEEE 1394 unit 304 connected to the second IEEE 1394 physical unit 408 employs a second bus it is unnecessary to reset buses when this device is connected or disconnected. Therefore, it is possible to form the internal network independent of the external network.

Procedures of delivering upstream data will now be described in more detail. First, there are assumed two signals upwardly delivered. The two signals correspond to upstream data delivered from the second IEEE 1394 physical units 408 and upstream data delivered from the asynchronous data receiving part 409.

Upstream data from the second IEEE 1394 physical unit 408 is delivered to the first IEEE 1394 physical unit 404 through a bus under the control of IEEE 1394 bridge unit 407. The first IEEE 1394 physical unit 404 also delivers the upstream data to the SG 31 through the first optical transceiver 402.

Upstream data from the asynchronous data receiving part 409 is inputted through the asynchronous data receiving part 409. The inputted asynchronous data is delivered to the first IEEE 1394 physical unit 404 through the control part 401 and the IEEE 1394 link unit 405. First IEEE 1394 physical unit 404 delivers the upstream data to the SG 31 through the first optical transceiver 402.

As described above by providing a network service platform apparatus employing the IEEE 1394 method in accordance with the principles of the instant invention it is not required to reset all buses of a network system when the AV appliances are connected to or disconnected from the network system.

Also, the present invention may employ an IEEE 1394b protocol method and a maximum distance between conventional appliances may be extended to 50 m. Accordingly, the present invention can be utilized in a wide space.

In addition, the network node apparatus employing the IEEE 1394 method according to the present invention is provided with an integrally formed existing power-line concentric plug so as to allow users to easy connection access.

While the invention has been shown and described with reference to certain preferred embodiments thereof, it will be understood by those skilled in the art that various changes in form and details may be made therein without departing from the spirit and scope of the invention. Consequently, the scope of the invention is not be limited to the embodiments disclosed herein, but should be defined by the appended claims and equivalents thereof.

1. A network service platform apparatus employing an IEEE 1394 protocol comprising:
a first optical transceiver connected to an external service gateway to receive and transmit data to the external service gateway;
a first IEEE 1394 protocol physical unit connected to the first optical transceiver to perform a physical layer operation of said IEEE 1394 protocol with respect to the received data, and to transfer data to the first optical transceiver;
an IEEE 1394 link unit connected to the first IEEE 1394 physical unit to deliver received isochronous data by performing a link layer operation of the IEEE 1394 protocol, and to transmit asynchronous data to the first IEEE 1394 physical unit by performing the link layer operation of the IEEE 1394 protocol with respect to the asynchronous data;
an API (Application Protocol Interface) connected to the IEEE 1394 link unit to output IEEE 1394 isochronous data by transforming IEEE 1394 isochronous data, having predetermined multimedia data formats;
an IEEE 1394 bridge unit having a first bus connected to the first IEEE 1394 physical unit and a second bus different from the first bus used by the first IEEE 1394 protocol physical unit, said bridge unit transmitting/receiving data between the first bus and the second bus;
a second IEEE 1394 physical unit connected to the IEEE 1394 bridge unit through the second bus and connected to an IEEE 1394 based apparatus using a bus independent from the IEEE 1394 network service platform apparatus; and
a control part which is connected to the IEEE 1394 link unit and the IEEE 1394 bridge unit and controls processing for the IEEE 1394 protocol and isochronous data.

2. The network service platform apparatus as claimed in claim 1, further comprising:
an asynchronous data receiving part for receiving asynchronous data from users, wherein the control part receives asynchronous data received by the asynchronous data receiving part and delivers the asynchronous data to the first IEEE 1394 physical unit through the IEEE 1394 link unit.

3. The network service platform apparatus as claimed in claim 1, further comprising:
a second optical transceiver which is connected to the first IEEE 1394 physical unit and communications with at least one second IEEE 1394 based network or node.

4. The network service platform apparatus as claimed in claim 1, wherein predetermined multimedia formats used for data transformation of the API include RGB (red, green, and blue) data for an AV (audio/video) apparatus.

5. The network service platform apparatus as claimed in claim 1, wherein predetermined multimedia formats used for data transformation of the API include component data including an image color difference signal for AV (audio/video) apparatus.

6. The network service platform apparatus as claimed in claim 1, wherein predetermined multimedia formats used for data transformation of the API include DVI (digital video interface) data for AV (audio/video) apparatus.

7. A device for interfacing to an IEEE 1394 based network for reducing interference when altering network configurations, said device comprising:
a first physical layer unit for performing a transformation operation on a physical layer of received IEEE-1394 protocol formatted data;
a second physical layer unit for communicating with an IEEE-1394 based receiving device;
a bridge unit including a first bus connected to said first physical layer unit and a second bus connected to said second physical unit;
a link layer unit in communication with said first physical layer unit, said link layer unit performing a link layer operation on received isochronous data provided by said first physical layer unit;
an API connected to said link layer unit for transforming said received isochronous data into predetermined multimedia format data;
a control unit connected to said link layer unit and said bridge unit.

8. The device as claimed in claim 7, further comprising:
an asynchronous data receiving unit for receiving asynchronous data.

9. The device as claimed in claim 7, further comprising:
a first receiver connected to an external network gateway for receiving data in said IEEE-1394 protocol format and providing said received data to said first physical unit.

10. The device as claimed in claim 7, further comprising:
a second optical receiver connected to said first physical layer unit for communicating with at least one external network or node.

11. The device as claimed in claim 7, wherein said predetermined format is selected from the group consisting of: RGB, component data including image color difference, and DVI data.

12. The device as claimed in claim 7, wherein said API is in communication with at least one apparatus selected from the group consisting of: television, computer, notebook computer, recorder, set-top box, HDTV, and radio.

13. The device as claimed in claim 7, wherein said first and second physical units, said link layer unit and said bridge unit are bi-directional devices.

14. The device as claimed in claim 9, wherein said first optical receiver is a transceiver.

15. The device as claimed in claim 10, wherein said second optical receiver is a transceiver.

16. The device as claimed in claim 8, wherein said asynchronous data is provided to said first physical unit via said link layer unit.
